(19) United States
(12) Patent Application Publication
(10) Pub. No.: US 2025/0130055 A1
(43) Pub. Date: Apr. 24, 2025

(54) SYSTEMS AND METHODS FOR ESTIMATING REMAINING RANGE OF A VEHICLE

(71) Applicant: Toyota Motor Engineering & Manufacturing North America, Inc., Plano, TX (US)

(72) Inventors: Dawei Chen, Milpitas, CA (US); Qi Chen, San Jose, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/491,290

(22) Filed: Oct. 20, 2023

(51) Int. Cl. G01C 21/34

(52) U.S. Cl. CPC G01C 21/3469

(57) ABSTRACT

A system includes a controller configured to determine a machine-learning model comprising kernels among a plurality of machine-learning models based on a task to be performed by a vehicle, select one of a plurality of predictors based on a hardware device of the vehicle, each of the plurality of predictors predicting energy consumption of the kernels in corresponding hardware device, estimate, using the selected predictor, energy consumption of running the machine-learning model for performing the task on the hardware device of the vehicle, and estimate remaining range of the vehicle based on the estimated energy consumption, and information of the vehicle, and a route of the vehicle.

### TECHNICAL FIELD

The present disclosure relates to systems and methods for estimating remaining range of a vehicle by predicting energy consumption of hardware devices running machine-learning models.

### BACKGROUND

Artificial Intelligence (AI) is one of key enabling techniques for autonomous vehicles. However, to perform Al algorithms and operations of on-vehicle sensors, the energy consumption may not be neglected. As a vehicle keeps consuming power along the driving, the total driving range of the vehicle may be reduced accordingly. Providing an accurate range estimation is important for drivers so that drivers can make a proper decision for refueling or recharging. However, conventional systems and methods do not accurately predict the energy consumption of performing AI algorithms.

Accordingly, a need exists for systems and methods that estimate remaining range of a vehicle based on accurate estimation of energy consumption.

### SUMMARY

The present disclosure provides systems and methods for estimating remaining range of a vehicle. With a plurality of predictors and a machine-learning model comprising kernels, the systems and methods accurately estimate the energy consumption of running the machine-learning model and the remaining range of the vehicle, thereby avoiding an undesirable situation.

In one or more embodiments, a system includes a controller configured to determine a machine-learning model comprising kernels among a plurality of machine-learning models based on a task to be performed by a vehicle, select one of a plurality of predictors based on a hardware device of the vehicle, each of the plurality of predictors predicting energy consumption of the kernels in corresponding hardware device, estimate, using the selected predictor, energy consumption of running the machine-learning model for performing the task on the hardware device of the vehicle, and estimate remaining range of the vehicle based on the estimated energy consumption, and information of the vehicle, and a route of the vehicle.

In another embodiment, a method for estimating remaining range of a vehicle, the method comprising determining a machine-learning model comprising kernels among a plurality of machine-learning models based on a task to be performed by the vehicle, selecting one of a plurality of predictors based on a hardware device of the vehicle, each of the plurality of predictors predicting energy consumption of the kernels in corresponding hardware device, estimating, using the selected predictor, energy consumption of running the machine-learning model for performing the task on the hardware device of the vehicle, and estimating the remaining range of the vehicle based on the estimated energy consumption, and information of the vehicle, and a route of the vehicle.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts an exemplary embodiment of estimating remaining range of a vehicle, according to one or more embodiments shown and described herein;

FIG. 2 depicts a schematic diagram of a system for estimating remaining range of a vehicle, according to one or more embodiments shown and described herein;

FIG. 3 depicts a flowchart for a method of estimating remaining range of a vehicle, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The embodiments disclosed herein include systems and methods for estimating remaining range of a vehicle. The vehicle may include various edge AI applications, such as sensor data, vehicle security, and traffic management. The edge AI applications, which involve intensive computing resources such as machine-learning models, deep learning algorithms, tend to consume a significant amount of energy. Mobile and edge deices including the edge AI applications, are typically powered solely by embedded batteries. As a result, heavy batter usage of the edge AI applications may results in subpar user experience. However, the energy efficiency of an edge device is more than its AI hardware capability in isolation. Instead, it is coupled with the on-device deep learning software stack, whose net performance is shrouded beneath the Deep neural networks (DNN) models and end-to-end processing pipeline of diverse edge AI applications. Thus, it becomes crucial to strike a balance between improving energy efficiency and enhancing performance in on-device deep learning for modern edge devices. With a plurality of predictors and a machine-learning model comprising kernels, the systems and methods accurately estimate the energy consumption of running the machine-learning model and the remaining range of the vehicle, thereby enabling transparency of power and energy consumption inside on-device deep learning across diverse edge devices.

The systems and methods may accurately estimate the remaining range of the vehicle by determining a machine-learning model comprising kernels among a plurality of machine-learning models based on a task to be performed by the vehicle, selecting one of a plurality of predictors based on a hardware device of the vehicle, each of the plurality of predictors predicting energy consumption of the kernels in corresponding hardware device, estimating, using the selected predictor, energy consumption of running the machine-learning model for performing the task on the hardware device of the vehicle, and estimating the remaining range of the vehicle based on the estimated energy consumption, and information of the vehicle, and a route of the vehicle, thereby avoiding an undesired situation.

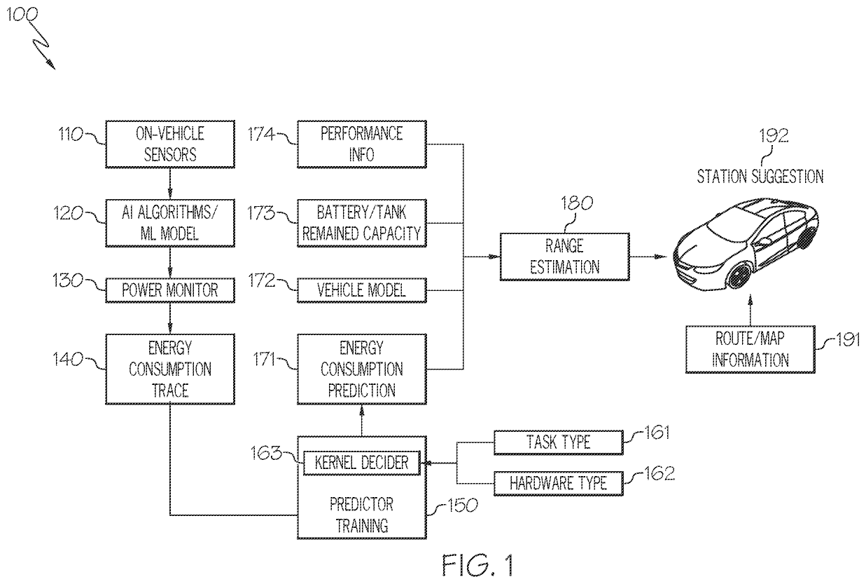

FIG. 1 schematically depicts an exemplary embodiment of estimating remaining range of a vehicle, according to one or more embodiments shown and described herein.

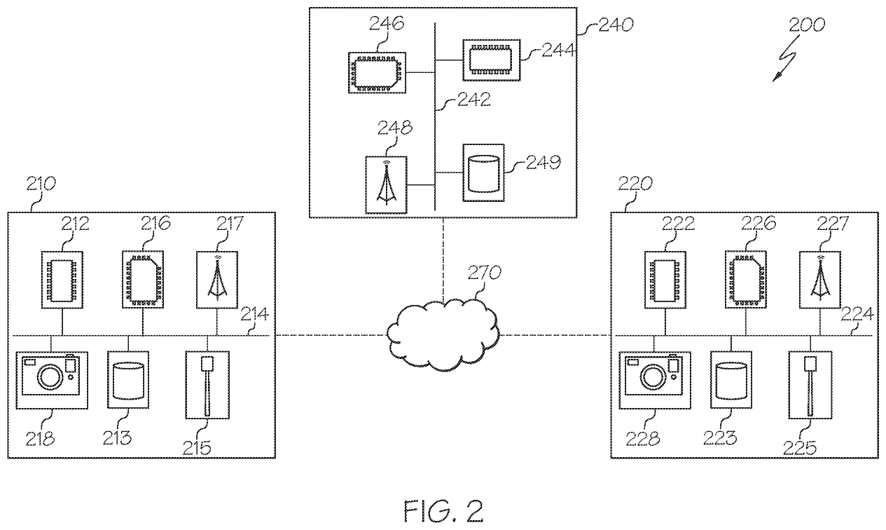

Referring to FIG. 1, the system 100 may include a vehicle. The vehicle may be a vehicle including an automobile or any other passenger or non-passenger vehicle such as, for example, a terrestrial, aquatic, and/or airborne vehicle. In some embodiments, the vehicle may be an autonomous driving vehicle. The vehicle may be an autonomous vehicle that navigates its environment with limited human input or without human input. The vehicle may be equipped with internet access and share data with other devices both inside and outside the vehicle. The vehicle may communicate with the server 240 (shown in FIG. 2) and transmit its data to the server 240 (shown in FIG. 2). For example, the vehicle transmits information about its current location and destination, its environment, information about a current driver, information about a task that it is currently implementing, and the like. The vehicle may include an actuator configured to move the vehicle.

Still referring to FIG. 1, the system 100 may collect data using on-vehicle sensors 110. The system 100 may determine a machine-learning model 120 comprising kernels among a plurality of machine-learning models based on a task 161 to be performed by a vehicle. Specifically, depending on the task to be performed by the vehicle, one of a plurality of machine-learning models may be selected.

The power consumption of the machine-learning model may be monitored by a power monitor device 130. The machining learning models may be the core of on-device deep learning and consume a major portion of both computational and energy resources on a vehicle. The term “edge device” refers a device that provides an entry point into enterprise or service provider core networks for the vehicle.

In embodiments, the plurality of machine-learning models may include a deep neural network, a convolutional neural network, and a recurrent neural network. The plurality of machine-learning models may also include supervised learning models such as decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning.

In embodiments, a deep neural network (DNN) model may consist of a sequence of primitive operations, such as convolution2D (conv), depthwise convolution2D (dwconv), activations, pooling, and fully-connected (fc) layer, which are organized into layers, allowing the network to learn complex patterns from input data.

The machine-learning model may comprise kernels. The kernels may run sequentially on the edge device. In some embodiments, the system 100 may fuse two or more of the kernels into a composite operation. For example, to enhance the computational efficiency of the machine-learning model inference, i.e., to reduce inference latency and avoid redundant memory access, kemel fusion or operator fusion may be a key optimization and has been incorporated in various state-of-the-art machine-learning model execution frameworks. For instance, three individual operations, conv, batch normalization (bn), and rectified linear unit (relu) may be fused into one composite operation, conv [symbol] bn [symbol] relu², to achieve inference acceleration on edge devices. This means that the entire sequence may be processed as a single step, which reduces memory access, since intermediate results do not need to be written to and read from memory, and kernel launch overhead. Hence, given its crucial role in runtime optimization, a kernel may be considered as one of the fundamental units for scheduling and execution in machine-learning frameworks, particularly on edge devices.

In embodiments, the task to be performed by the vehicle may include an automated drive, eye tracking, virtual assistance, mapping systems, driver monitoring, gesture controls, speech recognition, voice recognition, path planning, real-time path monitoring, surrounding object detection, lane changing, or combinations thereof.

In embodiments, the system 100 may determine a machine-learning model based on a complexity of a task to be performed by a vehicle. The complexity of the task may be determined by the requested time to complete the task, the amount of needed information to complete the task, or both. The complexity of the task may be identified by a zero (0) to ten (10) rating scale. The higher number of task may indicate a more complex task. For example, when the task includes path planning, real-time path monitoring, surrounding object detection, and lane changing, the system 100 may identify that the needed information for path planning includes departure location, destination location, map of the city, or combinations thereof. The system 100 may identify that the needed information for real-time path monitoring includes real-time traffic of the planned path, accident information, weather of the planned path, or combinations thereof. The system 100 may identify that the needed information for surrounding object detection includes the locations and speed of surrounding pedestrians and vehicles. The system 100 may identify that the needed information for lane changing includes the speed and distance of surrounding vehicles, current driving speed, current weather and visibility, speed limit, or combinations thereof. The system 100 may identify the complexity of path planning as 2, the complexity of real-time path monitoring as 5, the complexity of surrounding object detection as 8, and the complexity of lane changing as 8.

The system 100 may select one of a plurality of predictors 163 based on a hardware device 162 of the vehicle, each of the plurality of predictors predicting energy consumption of the kernels in corresponding hardware device. The system 100 may select one of a plurality of predictors 163 based on the hardware device 162 of the vehicle. In embodiments, the hardware device of the vehicle may include Central Processing Unit (CPU), Graphics processing unit (GPU), Random Access Memory (RAM), LiDAR, radar, camera, sonar, Dedicated Short Range Communications (DSRC), or combinations thereof. In some embodiments, the system 100 may select one of a plurality of predictors 163 further based on the task 161 performed by the vehicle.

In embodiments, the selected predictor may estimate energy consumption of running the determined machine-learning model including kernels. For example, the selected predictor predicts energy consumption of each of the kernels of the determined machine-learning model and sums up the energy consumption of the kernels. In some embodiments, a set of kernels of the determined machine-learning model are fused into composite operation, for example, conv [symbol] bn [symbol] relu². Then, the selected predictor predicts energy consumption of the composite operation on the hardware device of the vehicle and energy consumption of running remaining kernels of the determined machine-learning model on the hardware device of the vehicle, and sums the predicted energy consumption of the composite operation and the energy consumption of the remaining kernels.

When the machine-learning model includes a deep neural network, the system 100 may select one of a plurality of predictors based on a hardware device of the vehicle and based on a number of hidden layers, a number of hidden neurons, learning rate, dropout rate, or combinations thereof.

When the machine-learning model includes a convolutional neural network, the system 100 may select one of a plurality of predictors based on a hardware device of the vehicle and based on input dimension, a number of convolutional layers, a number of pooling layers, a number of fully connected layers, activation function, or combinations thereof.

When the machine-learning model includes a recurrent neural networks, the system 100 may select one of a plurality of predictors based on a hardware device of the vehicle and based on a number of gates, activation function, or both.

The system 100 may train the plurality of predictors 150 using a data set including energy consumptions of the kernels running on different hardware devices 162. The hardware device may be included in the vehicle. The system 100 may obtain additional data set from the remote vehicle (corresponding to the remote vehicle system 220 shown in FIG. 2) including energy consumptions of the kernels running on different hardware devices 162 to train the plurality of predictors 150. To collect a data set, the energy consumptions may be traced 140. The data set including energy consumptions of the kernels running on different hardware devices may be obtained by monitoring a power of the vehicle while running the machine-learning model including the kernels on the different hardware devices. In some embodiments, the energy consumption of each of the kernels running on a hardware device are obtained, and used for training the predictor for the corresponding hardware device such that the predictor accurately estimates energy consumption of each of kernels running on the corresponding hardware device. The system 100 may not require a model level data set for training the plurality of predictors. The system 100 may train the plurality of predictors using a random forest regression for handling a high dimensional spaces and being capable to model complex non-linear relationships.

The system 100 may estimate, using the selected predictor, energy consumption 171 of running the machine-learning model for performing the task on the hardware device of the vehicle. In embodiments, the selected predictors may be further trained during the system estimates the energy consumption of running the machine-learning model for performing the task on the hardware device of the vehicle. In embodiments, the system 100 may estimate energy consumption 171 of each of the kernels running on different hardware devices, and then sum energy consumption of each of the kernels to estimate the energy consumption of running the machine-learning model for performing the task on the hardware device of the vehicle.

The system 100 may estimate the remaining range 180 of the vehicle based on the estimated energy consumption 171, and information of the vehicle, such as vehicle model 172, vehicle type, vehicle manufacturing year, battery or tank remained capacity 173, cooling mechanism of the battery or tank, performance information of the vehicle 174, and autonomy system of the vehicle. The performance information of the vehicle 174 may include a top speed of the vehicle, acceleration of the vehicle, the gross vehicle weight rating (GVWR) of the vehicle, or combinations thereof. The autonomy system of the vehicle may include an algorithm type, a chipset type, or both. In embodiments, the information of the vehicle may include a vehicle model, a battery remained capacity, a fuel tank remained capacity, the velocity of the vehicle, the acceleration of the vehicle, or combinations thereof.

The system 100 may display the estimated remaining range 180 of the vehicle to a driver of the vehicle. The system 100 may display the estimated remaining range 180 of the vehicle to a display device of the driver of the vehicle. The display device may include a navigation device, a smartphone, a smartwatch, a laptop, a tablet computer, a personal computer, a wearable device, or combinations thereof.

The system 100 may display a refuel or recharge suggestion 192 to the vehicle based on the estimated remaining range 180 of the vehicle and a route of the vehicle 191. The route of the vehicle may include a route from the current location of the vehicle to an original destination. The system 100 may provide a refuel or recharge suggestion to the vehicle based on the estimated remaining range of the vehicle. For example, the system 100 may display the suggestion on a display device of the vehicle.

The system 100 may update the route of the vehicle based on the estimated remaining range 180 of the vehicle. In embodiments, the system 100 may update the route of the vehicle to from a current location of the vehicle to a closest refuel or recharge station when the estimated remaining range of the vehicle is shorter than a distance from a current location of the vehicle to an original destination.

FIG. 2 depicts a schematic diagram of a system for estimating remaining range of a vehicle, according to one or more embodiments shown and described herein.

Referring to FIG. 2, the system 200 includes a vehicle system 210, a remote vehicle system 220, and the server 240.

The vehicle system 210 includes one or more processors 212. Each of the one or more processors 212 may be any device capable of executing machine-readable and executable instructions. Each of the one or more processors 212 may be a controller, an integrated circuit, a microchip, a computer, or any other computing device. One or more processors 212 are coupled to a communication path 214 that provides signal interconnectivity between various modules of the system. The communication path 214 may communicatively couple any number of processors 212 with one another, and allow the modules coupled to the communication path 214 to operate in a distributed computing environment. Each of the modules may operate as a node that may send and/or receive data. As used herein, the term “communicatively coupled” means that coupled components are capable of exchanging data signals with one another such as electrical signals via a conductive medium, electromagnetic signals via air, optical signals via optical waveguides, and the like.

The communication path 214 may be formed from any medium that is capable of transmitting a signal such as conductive wires, conductive traces, optical waveguides, or the like. In some embodiments, the communication path 214 may facilitate the transmission of wireless signals, such as WiFi, Bluetooth®, Near Field Communication (NFC), and the like. The communication path 214 may be formed from a combination of mediums capable of transmitting signals. In one embodiment, the communication path 214 comprises a combination of conductive traces, conductive wires, connectors, and buses that cooperate to permit the transmission of electrical data signals to components such as processors, memories, sensors, input devices, output devices, and communication devices. The communication path 214 may comprise a vehicle bus, such as a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The vehicle system 210 includes one or more memory modules 216 coupled to the communication path 214 and may contain non-transitory computer-readable medium comprising RAM, ROM, flash memories, hard drives, or any device capable of storing machine-readable and executable instructions such that the machine-readable and executable instructions can be accessed by the one or more processors 212. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored in the one or more memory modules 216. The machine-readable and executable instructions may be written in a hardware description language (HDL), such as logic implemented via either a field-programmable gate array (FPGA) configuration or an application-specific integrated circuit (ASIC), or their equivalents. The methods described herein may be implemented in any conventional computer programming language, as pre-programmed hardware elements, or as a combination of hardware and software components. The one or more processors 212 along with the one or more memory modules 216 may operate as a controller for the vehicle system 210. The machine-readable and executable instructions, when executed by the one or more processors 212, cause the one or more processors 212 to determine a machine-learning model comprising kernels among a plurality of machine-learning models based on a task to be performed by a vehicle, select one of a plurality of predictors based on a hardware device of the vehicle, each of the plurality of predictors predicting energy consumption of the kernels in corresponding hardware device, estimate, using the selected predictor, energy consumption of running the machine-learning model for performing the task on the hardware device of the vehicle, and estimate remaining range of the vehicle based on the estimated energy consumption, and information of the vehicle, and a route of the vehicle.

The vehicle system 210 includes one or more sensors 218. One or more sensors 218 may be any device having an array of sensing devices capable of detecting radiation in an ultraviolet wavelength band, a visible light wavelength band, or an infrared wavelength band. One or more sensors 218 may detect the presence of the vehicle system 210, the presence of the remote vehicle system 220, the location of the vehicle system 210, the location of the remote vehicle system 220, the distance between the vehicle system 210 and the remote vehicle system 220. One or more sensors 218 may have any resolution. In some embodiments, one or more optical components, such as a mirror, fish-eye lens, or any other type of lens may be optically coupled to one or more sensors 218. In some embodiments, one or more sensors 218 may provide image data to one or more processors 212 or another component communicatively coupled to the communication path 214. In some embodiments, one or more sensors 218 may provide navigation support. In embodiments, data captured by one or more sensors 218 may be used to autonomously or semi-autonomously navigate the vehicle system 210.

The vehicle system 210 includes a satellite antenna 215 coupled to the communication path 214 such that the communication path 214 communicatively couples the satellite antenna 215 to other modules of the vehicle system 210. The satellite antenna 215 is configured to receive signals from global positioning system satellites. In one embodiment, the satellite antenna 215 includes one or more conductive elements that interact with electromagnetic signals transmitted by global positioning system satellites. The received signal is transformed into a data signal indicative of the location (e.g., latitude and longitude) of the satellite antenna 215 or an object positioned near the satellite antenna 215, by one or more processors 212.

The vehicle system 210 includes one or more vehicle sensors 213. Each of one or more vehicle sensors 213 is coupled to the communication path 214 and communicatively coupled to one or more processors 212. One or more vehicle sensors 213 may include one or more motion sensors for detecting and measuring motion and changes in the motion of the vehicle system 210. The motion sensors may include inertial measurement units. Each of the one or more motion sensors may include one or more accelerometers and one or more gyroscopes. Each of one or more motion sensors transforms sensed physical movement of the vehicle into a signal indicative of an orientation, a rotation, a velocity, or an acceleration of the vehicle.

Still referring to FIG. 2, the vehicle system 210 includes a network interface hardware 217 for communicatively coupling the vehicle system 210 to the server 240. The network interface hardware 217 may be communicatively coupled to the communication path 214 and may be any device capable of transmitting and/or receiving data via a network. The network interface hardware 217 may include a communication transceiver for sending and/or receiving any wired or wireless communication. For example, the network interface hardware 217 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 217 includes hardware configured to operate in accordance with the Bluetooth® wireless communication protocol. The network interface hardware 217 of the vehicle system 210 may transmit its data to the server 240. For example, the network interface hardware 217 of the vehicle system 210 may transmit vehicle data, location data, maneuver data, and the like to the server 240.

The vehicle system 210 may connect with one or more external ego vehicle systems (e.g., the remote vehicle system 220) and/or external processing devices (e.g., a cloud server, an edge server, or both) via a direct connection. The direct connection may be a vehicle-to-vehicle connection (“V2V connection”), a vehicle-to-everything connection (“V2X connection”), or an mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mm Wave) between the vehicles or between a vehicle and an infrastructure.

Vehicles may function as infrastructure nodes to form a mesh network and connect dynamically on an ad-hoc basis. In this way, vehicles may enter and/or leave the network at will, such that the mesh network may self-organize and self-modify over time. The network may include vehicles forming peer-to-peer networks with other vehicles or utilizing centralized networks that rely upon certain vehicles and/or infrastructure elements. The network may include networks using the centralized server and other central computing devices to store and/or relay information between vehicles.

Still referring to FIG. 2, the vehicle system 210 may be communicatively coupled to the remote vehicle system 220, the server 240, or both, by the network 270. In one embodiment, the network 270 may include one or more computer networks (e.g., a personal area network, a local area network, or a wide area network), cellular networks, satellite networks and/or a global positioning system and combinations thereof. The vehicle system 210 may be communicatively coupled to the network 270 via a wide area network, a local area network, a personal area network, a cellular network, a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the remote vehicle system 220 includes one or more processors 222, one or more memory modules 226, one or more sensors 228, one or more device sensors 223, a satellite antenna 225, a network interface hardware 227, and a communication path 224 communicatively connected to the other components of remote vehicle system 220. The components of the remote vehicle system 220 may be structurally similar to and have similar functions as the corresponding components of the vehicle system 210 (e.g., the one or more processors 222 correspond to the one or more processors 212, the one or more memory modules 226 correspond to the one or more memory modules 216, the one or more sensors 228 correspond to the one or more sensors 218, the satellite antenna 225 corresponds to the satellite antenna 215, the communication path 224 corresponds to the communication path 214, and the network interface hardware 227 corresponds to the network interface hardware 217). The remote vehicle system 220 may provide information about hardware device of the remote vehicle system 220 to the vehicle system 210 to select one of the plurality of predictors.

Still referring to FIG. 2, the server 240 includes one or more processors 244, one or more memory modules 246, a network interface hardware 248, one or more vehicle sensors 249, and a communication path 242 communicatively connected to the other components of the vehicle system 210. The components of the server 240 may be structurally similar to and have similar functions as the corresponding components of the vehicle system 210 (e.g., the one or more processors 244 correspond to the one or more processors 212, the one or more memory modules 246 correspond to the one or more memory modules 216, the one or more vehicle sensors 249 correspond to the one or more vehicle sensors 213, the communication path 242 corresponds to the communication path 214, and the network interface hardware 248 corresponds to the network interface hardware 217).

It should be understood that the components illustrated in FIG. 2 are merely illustrative and are not intended to limit the scope of this disclosure. More specifically, while the components in FIG. 2 are illustrated as residing within the vehicle system 210 the remote vehicle system 220, or both, this is a non-limiting example. In some embodiments, one or more of the components may reside external to the vehicle system 210, the remote vehicle system 220, or both, such as with the server 240.

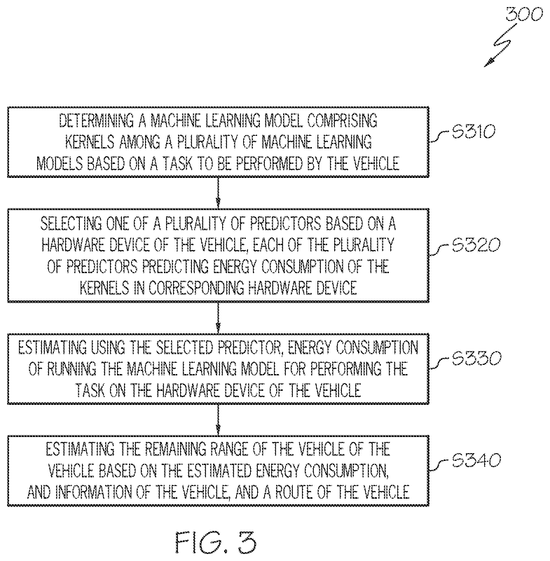

FIG. 3 depicts a flowchart for a method of estimating remaining range of a vehicle, according to one or more embodiments shown and described herein. The method 300 may be executed by the system 100 as depicted in FIG. 1 as described herein. Additionally, the method 300 will be described with reference to the elements depicted in FIG. 2.

Referring to FIG. 3, at step S310, a controller, for example, the controller of the vehicle, the controller of the server 240, or both, may determine a machine-learning model comprising kernels among a plurality of machine-learning models based on a task to be performed by the vehicle. In embodiments, the plurality of machine-learning may models include a deep neural network, a convolutional neural network, and a recurrent neural network. The task to be performed by the vehicle may include an automated drive, eye tracking, virtual assistance, mapping systems, driver monitoring, gesture controls, speech recognition, voice recognition, path planning, real-time path monitoring, surrounding object detection, lane changing, or combinations thereof.

Still referring to FIG. 3, at step S320, the controller may select one of a plurality of predictors based on a hardware device of the vehicle. Each of the plurality of predictors predicts energy consumption of the kernels in corresponding hardware device. The hardware device of the vehicle may include Central Processing Unit (CPU), Graphics processing unit (GPU), Random Access Memory (RAM), LIDAR, radar, camera, sonar, Dedicated Short Range Communications (DSRC), or combinations thereof. The controller may train the plurality of predictors using a data set including energy consumptions of the kernels running on different hardware devices.

Still referring to FIG. 3, at step S330, the controller may estimate, using the selected predictor, energy consumption of running the machine-learning model for performing the task on the hardware device of the vehicle.

Still referring to FIG. 3, at step S340, the controller may estimate the remaining range of the vehicle based on the estimated energy consumption, and information of the vehicle, and a route of the vehicle.

The controller may display the estimated remaining range of the vehicle to a driver of the vehicle. The controller may display a refuel or recharge suggestion to the vehicle based on the estimated remaining range of the vehicle and a route of the vehicle. The controller may update the route of the vehicle based on the estimated remaining range of the vehicle.

The present disclosure trains a kernel-based predictor and estimates energy consumption of each of hardware of the vehicle for utilizing one or more machine-learning models. The predictors of the present disclosure trained by the kernel-level dataset increases accuracy of estimating the energy consumption of machine-learning models.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system comprising:
a controller configured to:
determine a machine-learning model comprising kernels among a plurality of machine-learning models based on a task to be performed by a vehicle;
select one of a plurality of predictors based on a hardware device of the vehicle, each of the plurality of predictors predicting energy consumption of the kernels in corresponding hardware device;
estimate, using the selected predictor, energy consumption of running the machine-learning model for performing the task on the hardware device of the vehicle; and
estimate remaining range of the vehicle based on the estimated energy consumption, and information of the vehicle, and a route of the vehicle.

2. The system according to claim 1, wherein the information of the vehicle comprises a vehicle model, a battery remained capacity, a fuel tank remained capacity, velocity of the vehicle, acceleration of the vehicle, or combinations thereof.

3. The system according to claim 1, wherein the controller is further configured to:
fuse two or more of the kernels into a composite operation,
wherein the selected predictor estimates energy consumption of running the composite operation on the hardware device of the vehicle and energy consumption of running remaining kernels on the hardware device of the vehicle.

4. The system according to claim 1, wherein the task to be performed by the vehicle includes an automated drive, eye tracking, virtual assistance, mapping systems, driver monitoring, gesture controls, speech recognition, voice recognition, path planning, real-time path monitoring, surrounding object detection, lane changing, or combinations thereof.

5. The system according to claim 1, wherein the controller is further configured to:
display the estimated remaining range of the vehicle to a driver of the vehicle.

6. The system according to claim 1, wherein the controller is further configured to:
display a refuel or recharge suggestion to the vehicle based on the estimated remaining range of the vehicle.

7. The system according to claim 1, wherein the plurality of machine-learning models include a deep neural network, a convolutional neural network, and a recurrent neural network.

8. The system according to claim 1, wherein the controller is further configured to:
train the plurality of predictors using a data set including energy consumptions of the kernels running on different hardware devices.

9. The system according to claim 8, wherein the data set including energy consumptions of the kernels running on different hardware devices are obtained by monitoring a power of the vehicle while running the kernels on the different hardware devices.

10. The system according to claim 1, wherein the controller is further configured to:
update the route of the vehicle based on the estimated remaining range of the vehicle.

11. A method for estimating remaining range of a vehicle comprising:
determining a machine-learning model comprising kernels among a plurality of machine-learning models based on a task to be performed by the vehicle;
selecting one of a plurality of predictors based on a hardware device of the vehicle, each of the plurality of predictors predicting energy consumption of the kernels in corresponding hardware device;
estimating, using the selected predictor, energy consumption of running the machine-learning model for performing the task on the hardware device of the vehicle; and
estimating the remaining range of the vehicle based on the estimated energy consumption, and information of the vehicle, and a route of the vehicle.

12. The method according to claim 11, wherein the information of the vehicle comprises a vehicle model, a battery remained capacity, a fuel tank remained capacity, velocity of the vehicle, acceleration of the vehicle, or combinations thereof.

13. The method according to claim 11, further comprising:
fusing two or more of the kernels into a composite operation,
wherein the selected predictor estimates energy consumption of running the composite operation on the hardware device of the vehicle and energy consumption of running remaining kernels on the hardware device of the vehicle.

14. The method according to claim 11, wherein the task to be performed by the vehicle includes an automated drive, eye tracking, virtual assistance, mapping systems, driver monitoring, gesture controls, speech recognition, voice recognition, path planning, real-time path monitoring, surrounding object detection, lane changing, or combinations thereof.

15. The method according to claim 11, further comprising:
displaying the estimated remaining range of the vehicle to a driver of the vehicle.

16. The method according to claim 11, further comprising:
displaying a refuel or recharge suggestion to the vehicle based on the estimated remaining range of the vehicle.

17. The method according to claim 11, wherein the plurality of machine-learning models include a deep neural network, a convolutional neural network, and a recurrent neural network.

18. The method according to claim 11, further comprising:
training the plurality of predictors using a data set including energy consumptions of the kernels running on different hardware devices.

19. The method according to claim 18, wherein the data set including energy consumptions of the kernels running on different hardware devices are obtained by monitoring a power of the vehicle while running the kernels on the different hardware devices.

20. The method according to claim 11, further comprising:
updating the route of the vehicle based on the estimated remaining range of the vehicle.
